(19) United States
(12) Patent Application Publication
(10) Pub. No.: US 2024/0104593 A1
(43) Pub. Date: Mar. 28, 2024

(54) DIGITAL DEPOSIT RETURN SYSTEM

(71) Applicant: Twintag NV, Herentals (BE)

(72) Inventors: Paul CARPENTIER, Boechout (BE); Jan VAN RIEL, Geel (BE); Michiel DE BACKKER, Vosselaar (BE); Alexander CARPENTIER, Lier (BE)

(21) Appl. No.: 18/472,012

(22) Filed: Sep. 21, 2023

Related U.S. Application Data
(60) Provisional application No. 63/409,362, filed on Sep. 23, 2022.
(60) Provisional application No. 63/504,391, filed on May 25, 2023.

(51) Int. Cl. G06Q 30/0208; G06K 7/14

(52) U.S. Cl. CPC G06Q 30/0208; G06K 7/1417

(57) ABSTRACT

A mobile device scans a machine-readable code on a collection container; a Web page is downloaded to the device from a Web application which generates or retrieves a unique identifier for the device. The device then scans a can and the can's unique identifier is transmitted to the Web application to determine if the can had been scanned. If not, the device is alerted and a credit for the device's unique identifier is updated in a database. Or, the device scans a card to obtain a user unique identifier and then scans the can. The device scans a machine-readable code of the collection container to obtain a unique identifier for that collection container. Or, a user scans the card using an embedded scanning device of a collection container before scanning a can. The embedded device includes the unique identifier of the collection container which is sent to the Web application.

### CROSS-REFERENCE TO RELATED APPLICATIONS

This application claims priority of U.S. provisional patent application No. [P006P] 63/409,362, filed Sep. 23, 20252, entitled “DIGITAL DEPOSIT RETURN SYSTEM”, and U.S. provisional patent application No. [P006P2] 63/504,391, filed May 25, 2023, entitled “DIGITAL DEPOSIT RETURN SYSTEM WITH CLAIM CARD”, which are both hereby incorporated by reference.

### FIELD OF THE INVENTION

The present invention relates generally to returning recyclable items in a bin for a credit. More specifically, the present invention relates to use of unique identifiers to identify each item, users and bins in the context of a digital return system.

### BACKGROUND OF THE INVENTION

In many countries, littering is a lingering problem. Even if all kinds of litter reduction initiatives have delivered substantial results, publicly announced targets are often not met. Looking at the composition of the remaining litter, a very large fraction consists of food and beverage containers, the largest part thereof being beverage containers: think of aluminum cans and PET bottles.

Indeed, empty one-way beverage containers constitute approximately 40% of the volume in Belgium at this time. A deposit system similar to that used for collecting reusable glass bottles is seen by many governing bodies as an important part of a litter reduction strategy. Therefore, an increasing number of countries have introduced a deposit-based system for one-way packaging comparable to that often used for glass bottles, using so-called Reverse Vending Machines (RVMs), typically installed at retail locations. There, packages are being returned into a robotic device capable of recognizing packages and offering a credit coupon in exchange.

Return cycles, however, based on these systems do carry a serious economic and societal burden. The (expensive) machines need to be installed in consumer-accessible heated (prime) locations where power is available and (expensive) human oversight protects against vandalism. Maintenance and repair must be managed. Most often these end up in large retail locations in a suburban setting, where additional issues related to the transportation of the returned packages will appear: heavy traffic, requirements for large truck sizes (volume versus weight of the packaging). Generally, retailers are made to carry a substantial part of that burden. A Flemish study (OVAM, 2015) mentions a cost for such a system in Germany of 5.8 eurocents per package cycle, for a yearly total of approximately 40 billion packages (mostly PET bottles and aluminum cans).

Therefore, a system or systems for allowing any user to easily and seamlessly return litter such as cans, bottles, packaging, etc. in exchange for a credit is desirable.

### SUMMARY OF THE INVENTION

To achieve the foregoing, and in accordance with the purpose of the present invention, a digital deposit return system is disclosed that enables any person, with or without a smartphone, to deposit litter in a bin in return for a credit.

Embodiments of the system described below substantially reduce the lion's share of burdens associated with RVMs, significantly reducing the cost per package cycle by eliminating the most expensive steps in the regular process. The RVMs with their depreciations and other associated costs such as retail space, power and heating, maintenance, personnel attendance, and suburban truck transportation are all eliminated in the below embodiments. A distributed, smartphone-based or claim card-based process allows for a user to accrue credit in a public or private recyclables collection context. Unlike more traditional systems, there is no need for a retail outlet to intervene anywhere in the cycle, again avoiding substantial complexity and overhead, although participation by retail outlets is encouraged and desirable.

In a first embodiment, a Web application receives over a network connection from a mobile device of a user a unique identifier of a physical container or physical packaging based upon a scan; if the unique identifier has not been scanned before, a result sent to the mobile device indicates as such and the transaction may continue. In a variation, a code on a collection container is scanned resulting in a unique identifier for the collection container also being transmitted to the Web application. The mobile device may also generate (or retrieve from its storage) a unique identifier for the mobile device which is also transmitted to the Web application to allow this unique identifier to be updated with credit for the physical container.

In a second embodiment, a Web application receives over a network connection from a scanning device of a user a unique identifier of a physical claim card based upon a scan; a unique identifier resulting from a scan of a physical container or physical packaging is also sent to the Web application. If the unique identifier of the physical container has not been scanned before, a result sent to the scanning device indicates as such and the transaction may continue. In a variation, a code on a collection container is scanned resulting in a unique identifier for the collection container also being transmitted to the Web application. The unique identifier of the claim card may be updated in a database with credit for the physical container. The scanning device may be any smartphone of an individual or a dedicated smartphone securely attached at the collection container.

In a third embodiment, a Web application receives over a network connection from a scanning device embedded in a collection container a unique identifier of a physical claim card based upon a scan; a unique identifier resulting from a scan of a physical container or physical packaging is also sent to the Web application. If the unique identifier of the physical container has not been scanned before, a result sent to the scanning device indicates as such and the transaction may continue. In a variation, a unique identifier for the collection container also is transmitted to the Web application. The unique identifier of the claim card may be updated in a database with credit for the physical container.

In a fourth embodiment a time-locking technique is used to ensure that a user is at the collection container. A dynamic QR code on the collection container changes a data item within it dynamically. The dynamic QR code is scanned by a mobile device of the user or by a dedicated scanning device and the time-dependent data item is transmitted to the Web application. The Web application compares the received time-dependent data item with its own time-dependent data item (generated in the same way); if the two match then the transaction continues.

In a fifth embodiment a time-locking technique is used to ensure that a physical container or physical packaging (e.g., a can) is at the collection container. A Web application sends a time-dependent parameter to the mobile device, scanning device or embedded scanning device which dictates how a camera of the device scans, interprets or modifies an image or video during a scan. When the image or video from the scan of the can is received at the Web application from the device, the Web application determines if the received image or video was modified according to the time-dependent parameter. If so, then the transaction continues.

In a sixth embodiment a time-locking technique is used to ensure that the user is at the collection container and that a physical container or physical packaging (e.g., a can) is at the collection container. The top of the collection container may be shaped to accommodate the scanning of both the can/bottle and the dynamic (time-dependent) QR code together in a single picture (image or video) to prove their simultaneous presence, time and location. Optionally, the picture can be uploaded and analysed for artefacts.

### BRIEF DESCRIPTION OF THE DRAWINGS

The invention, together with further advantages thereof, may best be understood by reference to the following description taken in conjunction with the accompanying drawings in which:

FIG. 1 illustrates a digital deposit return system (DDRS) 100 enabled with a user smartphone.

FIG. 2 is a flow diagram describing how the system of FIG. 1 operates.

FIG. 3 illustrates a digital deposit return system (DDRS) 300 enabled with any smartphone or a dedicated smartphone.

FIG. 4 is a flow diagram describing how the system of FIG. 3 operates.

FIG. 5 illustrates a digital deposit return system (DDRS) 500 enabled with a built-in scanning device 510, such as any suitable smartphone.

FIG. 6 is a flow diagram describing how the system of FIG. 5 operates.

FIGS. 7A and 7B illustrate a computer system suitable for implementing embodiments of the present invention.

### DETAILED DESCRIPTION OF THE INVENTION

The DDRS (Digital Deposit Return System) will be described below in terms of one-way beverage containers: we will use the term “can” as a placeholder for the larger category of other one-way food and beverage containers such as PET bottles and other recyclable food packaging such as used for dairy products and other foodstuffs. In other words, any kind of one-way container or packaging can potentially be collected and processed in the same way as long as it is able to include, display or have affixed to it a unique code or tag. Similarly, when we refer to “QR code” below, we include any kind of machine-readable code (including two-dimensional codes such as QR codes and data matrix codes, one-dimensional codes such as bar codes, alphanumeric codes, etc.) that can be scanned or otherwise detected by a smartphone or similar scanning device. When we speak of smartphones, scanning devices, etc. we mean the whole class of mobile devices that perform the functions described, including smartphones, tablet computers, smartwatches, custom or dedicated scanning computers, etc.

In addition to or instead of a QR code being affixed to a collection container, any physical electronic tag may be fixed to a collection container that can be detected wirelessly, such as NFC (near-field communication) tags, RFID tags, etc. These physical tags are most likely used on collection containers or collection bins, but may also be used when embedded within a claim card (described below) and even on a food or beverage container to be recycled, although at greater cost. Depending upon the embodiment chosen and a particular implementation, such a physical tag may supply only the unique identifier of the collection container, food or beverage container, or claim card, or may also supply a URL in order to open up and download a Web page to a mobile device or scanning device. By way of example, when a mobile device equipped with an NFC reader scans (or otherwise touches, taps or is in close proximity to) an NFC tag the reader then opens up a Web page identified by the URL obtained from the NFC tag. Either static or dynamic NFC tags may be used. As known, a static NFC tag provides the same response each time it is scanned, while a dynamic NFC tag will provide a different response each time (i.e., it is time varying) along with the unique identifier and URL it is programmed to provide. Since the system implementer can program a dynamic NFC tag and will know what its time varying responses will be and when they will occur, scanning an NFC tag can be used to authenticate an object, such as a collection container. As described below, when a user scans such a dynamic NFC tag and receives the time-varying response, this time-varying response can then be provided to a Web application to prove that the user is actually present at the collection container. In one particular embodiment, the dynamic NFC tag that is used is NXP's NTAG® 424 DNA line.

### System Overview

On the production line for food and beverage containers and packaging, a unique identifier is applied to every container using a machine-readable code, such as a QR code. The unique identifier may be printed, affixed with adhesive, painted on, stamped on, laser etched, or applied in other manners typically used on containers and packaging. A physical tag with a unique identifier may also be applied to the container packaging. The beverage or food producer then sells the product to a distribution or retail outlet, typically including the deposit in the price. The retail outlet then sells the product to the consumer at its regular price plus the deposit. Although a deposit is typically included in the price, for purposes of the below embodiments it is not required.

Anyone may claim back that deposit (or any suitable amount if a deposit is not required) digitally as a credit or a wallet transaction. He or she does this by scanning an empty can with a smartphone when he or she is about to dispose of the can into an appropriate recycling container, as follows. Scanning the unique identifier (e.g., QR code) present on every registered collection container opens up a Web page containing a specialized scanner on the smartphone, capable of very efficiently scanning one or more cans in rapid succession. The recycling container may be a public container, a beach trash can, etc. but also a selective collection bag at home. For each can scan, the deposit is credited to the user in a database. The collected cans are then collected, transported and processed as usual.

In an embodiment that uses markings on the can that contain a URL, scanning the marking on the can also be used to open the Web page. In this case, the user can scan the marking of the recycling container from the Web page that opens. The main objective remains to tie both unique identifiers together in a single transaction.

In an embodiment that does not require a person to own or use a smartphone, the collection container includes a built-in dedicated scanning device (possibly implemented using a customized smartphone), the person scans a claim card displaying a unique identifier in the form of a machine-readable code (or incorporating a physical tag), scans one or more cans in rapid succession, and credit for the cans is posted to the claim card identifier in a database.

In a variation on the above embodiment that does not require a person to own a smartphone, the collection container does not include a built-in dedicated scanning device, but the person may use a dedicated scanning device (i.e., a custom smartphone) located close to the collection container or may use the smartphone of any person who will lend it for a brief use, or will perform the operation. The claim card and cans are scanned as above and credit is posted to the claim card identifier in a database.

Note that all the functions described below can be triggered and executed from any standard smartphone, using standard Web technology, without the need for downloading an application to a smartphone or for creating a user account upfront. And of course, the latter two embodiments above do not require that the user own a smartphone. Even when a smartphone is borrowed in the third embodiment above, no application needs to be downloaded, and no user account is needed. Further, use of a claim card does not require a user account, any login, any password or any registration requiring personal information of the user. This strategy lowers the threshold of entry for the general public: applications, downloads, accounts and logins are known as major obstacles in the adoption of these kinds of public systems. Nevertheless, in cases where it should be desirable to interface or integrate with applications of other systems or accounts, the use of applications and accounts remains entirely possible for these other systems.

### Digital Deposit Return System with User Smartphone

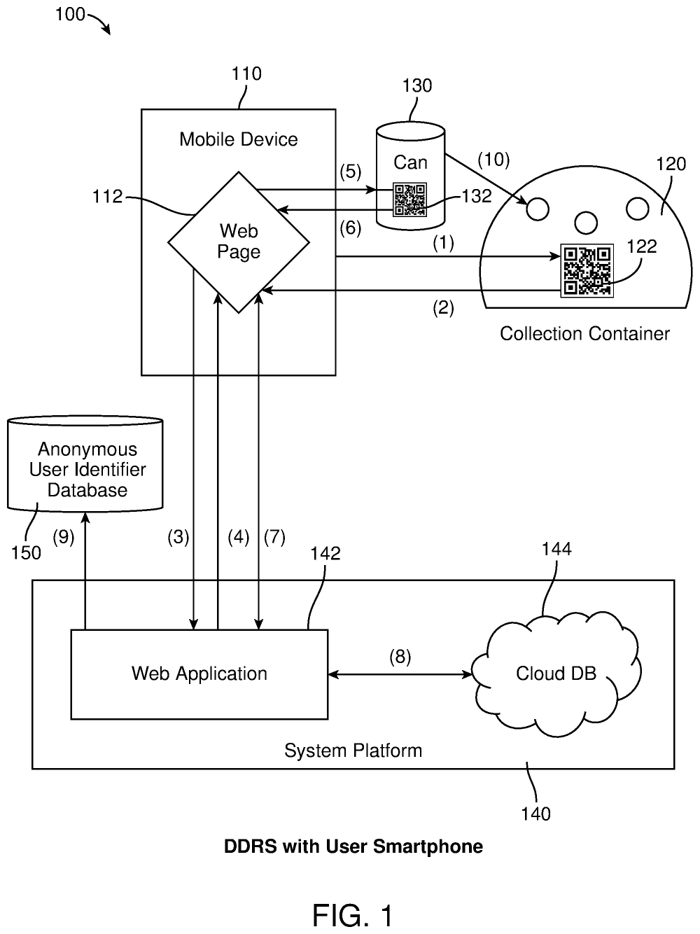

FIG. 1 illustrates a digital deposit return system (DDRS) 100 enabled with a user smartphone. In this embodiment a person uses his or her smartphone in order to scan a collection container and cans for recycling which will be deposited into the container. It is preferable that a person's own smartphone be used in that an anonymous user identifier will be stored within the smartphone.

Shown is a user's mobile device 110, such as a modern smartphone (most often Android- or Apple iOS-based today) with a cellular data connection (typically 4G or 5G today), and a built-in camera with built-in QR code detection and/or an NFC tag detection capability. Alternatively, for embodiments where a different type of machine-readable code is used, or for where a different type of physical tag is used, mobile device 110 may come equipped with standard hardware and software to read those codes or tags. An HTML5 Web browser (Safari or Chrome are typical today) hosts the user interface, driven from the Web servers on the above-mentioned platform in the cloud.

Collection container 120 is any suitable container, bin, receptacle, bag, etc. suitable for holding food and beverage containers to be recycled. These collection containers can span a wide range of physical shapes and sizes, depending on their use and location. The simplest form may be a sturdy collection bag; there may also be the traditional “trash” cans for use indoors and outdoors, large return containers (similar to glass collection containers, to put in public waste collection locations and facilities), etc. Each of these collection containers will have a serialized QR code 122 (or another suitable machine-readable code or physical tag) that enables multiple functions for persons interacting with the container. This code 122 may be affixed to, or located upon, collection container 120 in any suitable manner, or may be located in close proximity to the collection container. In one particular embodiment, code 122 is a data matrix code or an NFC tag.

As mentioned earlier, can 130 is any suitable food or beverage container such as a glass or plastic bottle, tin or aluminum can, carton, or any type of food or beverage packaging on which it is practical to place a machine-readable code 132. Code 132 may be a serialized QR code, although these may not be practical from a high-speed production perspective. Other types of machine-readable codes may be used or a physical tag may be fixed to or placed within the container. In one particular embodiment, a data matrix code is used. In an alternative embodiment, a hybrid code is used in which a non-serialized QR code (which varies per large batch of cans) is placed upon the can, in addition to a machine-readable code, possibly laser-etched (Direct Part Marking) on the bottom of the can.

Preferably, the code is applied to the can in a production facility, is machine-readable, and includes an identifier uniquely identifying that particular can that is sufficiently long so that it can be considered unguessable for all practical purposes. Given the volume of food and beverage containers produced, it is preferable that the code is able to be applied at high-speed on a typical production line. A machine-readable code such as a QR code is able to launch a UI process and a user workflow (via a URL of a Web page) as well as serve as a unique identifier for a particular can.

System platform 140 includes any number of scalable Web server computers executing one or more Web applications 142 in communication an industrial strength, hyper-scalable cloud database 144, capable of storing and handling the tens of billions of records—one for every uniquely identified food or beverage container that is produced—that executes upon suitable server computers located within a corporation or within a third-party cloud service such as Amazon Web Services (AWS) and available over the Internet or other private network. Database 144, 344 or 544 may also store records for each collection container based upon its unique identifier.

Anonymous user identifier database 150 is any suitable scalable database executing upon a server computer (which may be located within system platform 140 or at a remote location) capable of handling the many thousands or millions of records that will associate an anonymous identifier for each user of the system with the credit that each has accrued when returning food or beverage containers. It is notable that database 150 does not need to include personally-identifiable information about each user such as an e-mail address, name, password, user name, or other type of account information.

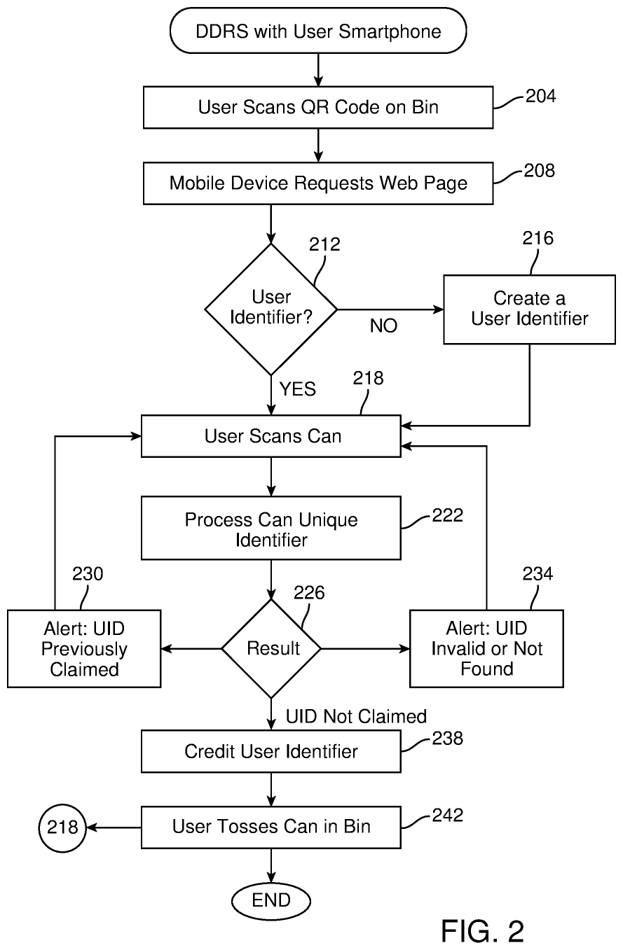

FIG. 2 is a flow diagram describing how the system of FIG. 1 operates. At this point in time can 130 has entered the stream of commerce. The can produced by a manufacturer has a QR code applied (or other machine-readable code or physical tag), has been filled, and has been sold to a retail outlet (which price may have included a deposit). The retail outlet then sells the can to the consumer at a suitable price (which may include the deposit). There is no other requirement for a retail outlet in this basic scenario, although a retail outlet may choose to host a collection container on its property or provide suitable hardware and software to allow any person to check their credit balance, redeem their credit at the retail outlet for cash or a product as will be described in more detail below.

In step 204 (arrows 1 and 2) any person in possession of a mobile device (such as a smartphone) desiring to deposit can 130 into collection container 120 for credit scans QR code 122 on the container 120 with their smartphone. As mentioned earlier, the person will be in the presence of any suitable collection container such as a collection bag, recycling can, etc. that includes QR code 122. As known in the art, scanning QR code 122 with the camera of the smartphone provides the context of that container to the smartphone, typically including a Web site address and Web page identifying Web application 142 within system platform 140, as well as other information such as a unique identifier of collection container 120. Scanning code 122 suggests that the user is at the collection container 120 (and presumably will toss the can in the container). Precautions can be taken to prevent fraud as described in more detail below. The QR code itself typically does not contain any other information, but the associated record in cloud database 144 may contain attributes such as readable name, address, park location numbering schemes, GPS coordinates, number of packages scanned since last emptying round etc.

In step 208 (arrows 3 and 4) the smartphone queries Web application 142 over an Internet connection (or cellular connection, Wi-Fi connection, etc.), supplying any information about the collection container, and downloads the identified Web page. This Web page opens in a browser of the operating system on the user's smartphone and includes a custom scanner window, various auxiliary options of the Web application 142; the custom scanner will use the camera APIs to show a camera viewfinder window inside of the Web page for use in scanning the can.

In step 212 a small amount of custom code that has been downloaded along with the Web page checks to see if the smartphone includes an anonymous user identifier (pertaining to the DDRS) indicating that the user has used the system before. This user identifier may be stored within the smartphone in different locations; in one embodiment, it is stored within the cache of the browser, for example, in a record associated with the domain name of Web application 142. In some jurisdictions (and depending upon the operating system of the smartphone used) local law or convention dictates that such storage in a browser cache may not last indefinitely; it must be erased after a week or two or one month of not using the Web page. Although the user identifier will persist within this time period in the cache, if a longer time is needed then the user identifier may also be stored by storing a bookmark for Web page 112 on the home screen or lock screen of the mobile device 110 (i.e., where icons for applications are typically stored); the user identifier is then placed in storage associated with that bookmark and will persist indefinitely. Other persistent storage locations within the smartphone may also be used.

If no user identifier is found then in step 216 the custom code creates an anonymous user identifier and stores it in the suitable location within the smartphone. As mentioned above, there is no user account in the system nor in database 150; each accrual of value based upon the use of a particular user smartphone is only associated with an anonymous user identifier in database 150 which is based upon, associated with, or the same as, the anonymous user identifier created in this step. In one particular embodiment, the anonymous user identifier is a 128-bit unique identifier. If such an identifier is found in step 212, the control moves on to step 218.

In step 218 (arrows 5 and 6) the user scans the QR code 132 on can 130 using the camera of his or her smartphone in conjunction with the custom scanner window of the downloaded Web page. As mentioned, code 132 includes a unique identifier (UID) that uniquely identifies that particular can 130 that is captured by the code of the Web page 112.

In step 222 (arrows 7 and 8) numerous interactions occur between Web page 112, Web application 142 and the cloud database 144 in order to produce a result which is sent in the form of a code from cloud database 144 through to the Web page 112 in the smartphone. The can UID is sent from the smartphone to the Web application 142 and the Web application queries the records of the cloud database 144 using the UID in order to determine if this is a valid can UID, and if so, has this can already been scanned before. If this is a valid can UID and the can has not been scanned before, then the record corresponding to the unique identifier of the scanned can is marked as “deposit claimed” (or other such indication that this can has now been scanned and may not be scanned again in order to obtain credit). Other additional metadata may also be recorded within the record for this particular can such as the unique identifier of the collection container, date, time stamp and the geolocation of the collection container, and each record may also include the deposit value of the can which may be transmitted back to the smartphone. A result is returned to the Web page 112 on the user's mobile device.

In step 226 the result is displayed on the user's smartphone to indicate the status of the can that was just scanned using the custom code of the Web page 112. This result may be indicated visually using text, graphics, color, etc. or may be displayed audibly using tones, music, a recorded message (e.g., “can accepted”), etc. Thus, at the moment of a scan of a can, the audio or visual feedback from the smartphone to the user is given to indicate one of three possible results: 1 [a successful scan and deposit claim]; 2 [valid UID but deposit claimed previously]; or 3 [scan error]. In other words, a result of 1 indicates that the can UID was found in the can database database and has not previously been scanned and claimed, accordingly, control moves to step 238. A result of 2 indicates that the UID found on the can is a valid UID found in the database, but this can has already been scanned and claimed by someone else and no deposit will be credited; accordingly, control moves to step 230. A result of 3 indicates that no UID was found during the scan, any UID found is not valid or some other error; accordingly, control moves to step 234. After the display of alert in steps 230 or 234 control returns to step 218 and the Web page and smartphone are immediately ready to scan another can. Thus, if more cans are present they can be scanned in rapid succession without needing to touch any other UI elements like buttons or icons.

In step 238 (arrow 9) the anonymous user identifier originally identified in step 212 or created in step 216 upon the user's mobile device is credited in database 150 with a value corresponding to can 130. This value may be equivalent to the original deposit paid for the can (if any), or may be a greater or lesser amount. Preferably, the value for the can is obtained from cloud database 144, but in alternatives it may be obtained from the can itself, from the Web application, or the anonymous user identifier database 150.

During interaction (7) the anonymous user identifier (whether already existing within the smartphone or created in step 216), is provided to Web application 142 which may then update database 150 with this user identifier and the value to be credited to that identifier during interaction (9). If the identifier already exists within the database in a record then the current value is added to the existing value at that record, while if no identifier exists then a new record is created with the new value. In step 242 the user tosses can 130 into collection container 120 and continues scanning and depositing other cans or the process ends. The collection container is then emptied or picked up, transported and processed as usual.

### Digital Deposit Return System with No Requirement for a User to Own a Smartphone

In addition to the above challenges described in the Background, the above smartphone-based DDRS embodiment proves difficult for those in any population group who do not own a smartphone, or for those who cannot or do not wish to use a smartphone, or even to those who do own a smartphone but for whatever reason to not have it with them.

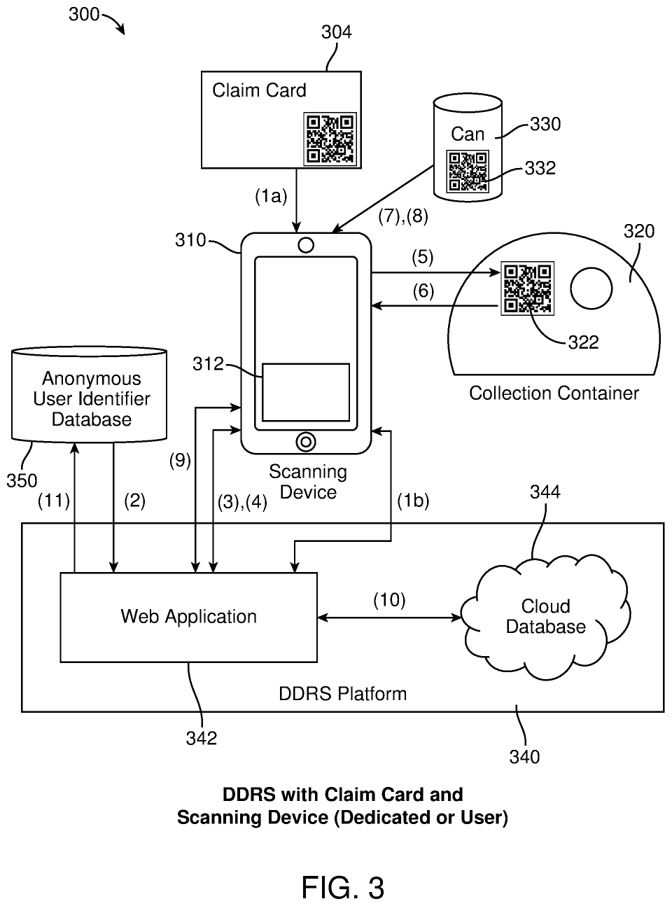

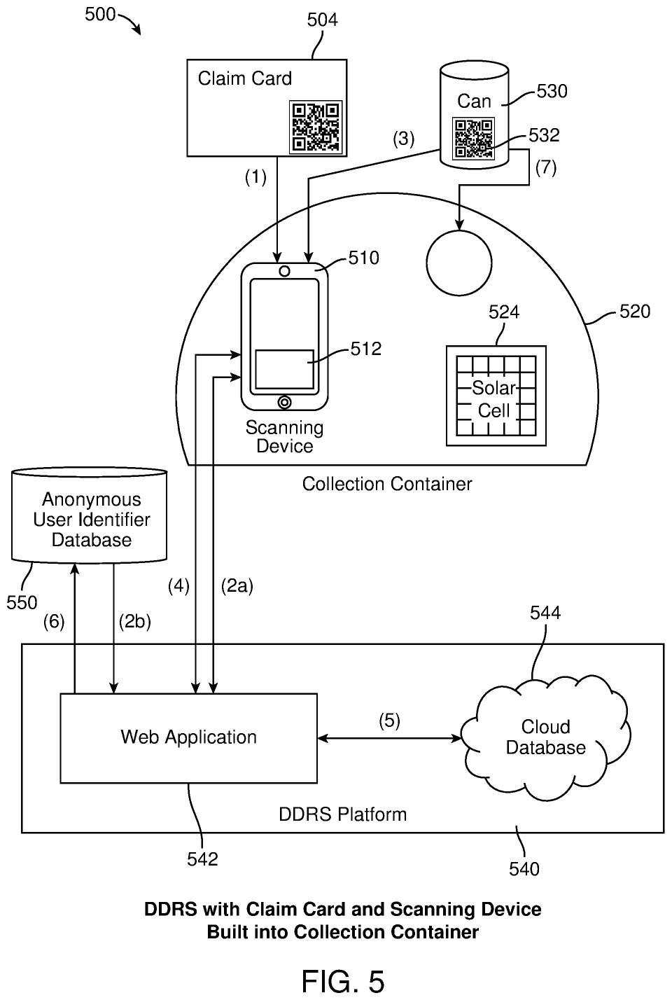

Accordingly, in addition to the DDRS embodiment of FIG. 1, presented below are DDRS embodiments in FIG. 3 and in FIG. 5 that do not require a person to own a smartphone nor to carry one in order to take advantage of the DDRS. These device-less DDRSs include a simple anonymous card with a unique serialized QR code that is capable of accruing a deposit credit when scanned, known as a ClaimCard™. The credit on this card can be transferred to another computing device, e.g. in a retail setting in exchange for cash or as payment for goods and services, or in a community situation where a support worker pays out money for the credit as appropriate.

A claim card is inexpensive and may be available from many locations, including the typical retail locations where the public buys their beverages and food. Further, a person may have multiple claim cards. When an individual has cans or bottles to return he or she may: kindly ask someone else to do it using the other person's smartphone and the individual's claim card; use the individual's own dedicated scanning device (e.g. a ClaimScanner described below) or a shared one in the apartment, community center, small retail location, etc.; use any collection container with an embedded scanning device (e.g. a ClaimBin described below) that may be encountered in streets, parks, in larger retail location or other places. At the end of the transaction the individual may verify his or her accrued deposit on the screen of the smartphone or ClaimScanner.

Once any number of cans are scanned, the individual may check his or her accrued deposits independently, he or she simply scans the QR code on the card using

the standard camera scanner function of any smartphone. It will immediately show the total deposit, with a button next to it to provide details or a transaction log. On that same screen, depending on the local collection system, there are options to be selected and an optional PIN code to be set that allows for transfer of funds off the card. When an individual wishes to exchange his or her deposit against money or goods, this may be done by another user using a smartphone or a ClaimScanner. This other user may be a retailer, a family member, a caretaker, a bank, etc. This other user may offer the owner of the claim card goods, cash or bank deposits in return. To do so, they use a deposit transfer function on their device and scan the claim card's QR code; the individual provides the correct PIN code if required. An alternative to the use of a PIN to protect the credit on the card may be a form of barcode or QR code on the back of the ClaimCard. The intention is to prevent the unauthorized transfer of credit by means of a simple picture of the ClaimCard.

Further included in these DDRSs is a simple, ruggedized, and dedicated scanning device (any suitable smartphone, as described below) known as a ClaimScanner™ that scans the card and that may be used in different scenarios:
at home (a “home scanner”)
in a back recycling room of a retail outlet (a “retail scanner”)
in a community setting (e.g. garbage room of an apartment building)
or built into a recycling bin with a solar cell for charging (for parks and public spaces)

All of a sudden, smartphone ownership or constant possession is not required for citizens to participate in the DDRS process—only a small, credit-card sized, anonymous plastic or cardboard card is sufficient. The claim card works in the embodiments below which use the dedicated scanning device. In addition, even though smartphone ownership or possession is not required, in the DDRS embodiment of FIG. 3 below the user may choose to use a borrowed smartphone from anyone or their own smartphone.

Preferably, such a dedicated scanning device is any smartphone having the following features: processor, camera scanner, a 3/4/5G connection, a WiFi connection, a screen or LEDs, sound, a GPS, low power consumption, automatic power-off recovery, the ability to be wall mounted and connected to AC, and tamper proof. Not all of these features are required, e.g. sound, a GPS, AC, and wall-mounted are not a necessity; the below drawings and explanation make clear which features are necessary for operation of the DDRS.

In one particular embodiment, a solid, qualitative and economical way to achieve the best results is by using a dedicated low-cost Android smartphone that is “locked” into a limited functional UX (so-called “kiosk” mode) and mounted inside a special purpose ruggedized enclosure. Although not required, such a scanning device preferably: is a basic Android smartphone inside a ruggedized enclosure, is made from recycled materials, can be physically secured using a chain to a wall or other fixed structure, can be wall mounted at about a 45 degree angle, scans lid-printed data matrix codes, features a subscriptionless 4G data connection, and is stateless with no personalization and no mail flows. As mentioned, such a ruggedized scanning device may be used at home, in a retail outlet, in an apartment building, etc.

Thus, there is no requirement to own or carry a smartphone, only an anonymous, free card by which any person may collect and scan food and beverage containers for credit using the dedicated, ruggedized scanning device provided or any smartphone lent by a person nearby.

FIG. 3 illustrates a digital deposit return system (DDRS) 300 enabled with any smartphone or a dedicated smartphone. In this embodiment a person may use a dedicated, ruggedized smartphone located near the collection container, may use the smartphone of any person nearby, or may use their own smartphone (not required) in order to scan a collection container and cans for recycling which will be deposited into the container.

Shown is a claim card 304 that includes a machine-readable code such as a QR code (or a physical tag) that includes a unique identifier for that card which will be used to accrue and store value for deposits made into the anonymous user identifier database 350. The card unique identifier (CUID) is associated with the physical card but in practice it represents the user who carries the card, who uses the card to make deposits and who then later uses the card to withdraw or spend value from the database, although the CUID or the card does not include personal user identification. Card 304 may be of any size, typically it will be the same size as a credit card, although it may be even smaller and of any shape as long as it has a surface large enough for a machine-readable code that can be scanned (or suitable to contain a physical tag). In the preferred embodiment below in which card 304 is scanned first, its QR code also includes a Web address that identifies a Web page of Web application 342, described in greater detail below.

Shown also is a mobile device 310, such as a modern smartphone (most often Android- or Apple iOS-based today) with a cellular data connection (typically 4G or 5G today), and a built-in camera with built-in QR code detection and/or an NFC tag detection capability. As mentioned above, device 310 may be the smartphone of any person (not necessarily the person with claim card 304 who wishes to redeem a can) or may be the dedicated, ruggedized scanning device located in close proximity to collection container 320. Alternatively, for embodiments where a different type of machine-readable code is used, or for where a different type of physical tag is used, mobile device 310 may come equipped with standard hardware and software to read those codes or tags. An HTML5 Web browser (Safari or Chrome are typical today) hosts the user interface, driven from the Web servers on the above-mentioned platform in the cloud.

Collection container 320 is any suitable container, bin, receptacle, bag, etc. suitable for holding food and beverage containers to be recycled. Each of these collection containers will have a serialized QR code 322 (or another suitable machine-readable code or physical tag) that enable multiple functions for persons interacting with the container. This code 322 may be affixed to, or located upon, collection container 320 in any suitable manner, or may be located in close proximity to the collection container. In one particular embodiment, code 322 is an NFC code or a data matrix code.

As mentioned earlier, can 330 is any suitable food or beverage container such as a glass or plastic bottle, tin or aluminum can, carton, or any type of food or beverage packaging on which it is practical to place a machine-readable code 332. Code 332 may be a QR code. Other types of machine-readable codes may be used or a physical tag may be fixed to or placed within the container. In one particular embodiment, a data matrix code is used. In an alternative embodiment, a hybrid code is used in which a non-serialized QR code (which varies per large batch of cans) is placed upon the can, in addition to a machine-readable code, possibly laser-etched on the bottom of the can, or on the clip on the top of the can.

System platform 340 includes any number of scalable Web server computers executing one or more Web applications 342 in communication with an industrial strength, hyper-scalable cloud database 344, capable of storing and handling the tens of billions of records—one for every uniquely identified food or beverage container that is produced—that executes upon suitable server computers located within a corporation or within a third-party cloud service and available over the Internet or other private network.

Anonymous user identifier database 350 is any suitable scalable database executing upon a server computer (which may be located within system platform 340 or at a remote location) capable of handling the many thousands or millions of records that will associate an anonymous identifier for each user of the system with the credit that each has accrued when returning food or beverage containers. It is notable that database 350 does not need to include personally-identifiable information about each user such as an e-mail address, name, password, user name, or other type of account information.

In the preferred embodiment described below card 304 is scanned first and its code includes a Web address used to download a Web page. Since the machine-readable codes on card 304, can 330 and container 320 may be scanned in any order, any of these codes may include the Web address of the Web page of Web application 342. If any one of these codes is scanned first, the Web page along with its custom scanner window is downloaded and used to scan the other two codes with their own unique identifiers. Note that the can will likely be marked with a shorter code for production efficiency and thus not contain a full Web address, although one may be used. Also, note that any of the claim card, can or collection container may be scanned first, and the first one to be scanned will include the address of the Web page.

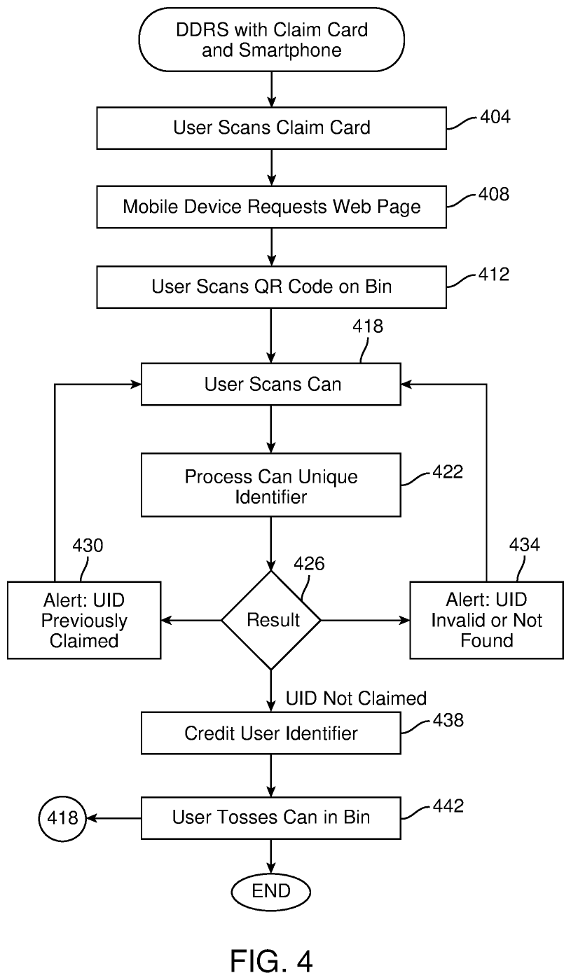

FIG. 4 is a flow diagram describing how the system of FIG. 3 operates. At this point in time, can 330 has entered the stream of commerce as described above. In step 404 (arrow 1a) any person scans the QR code on claim card 304 using scanning device 310 (which may be any individual's smartphone or may be a dedicated smartphone located adjacent to, or permanently affixed close to, collection container 320). Typically, the person in possession of claim card 304 wishes to deposit can 330 in order to obtain its deposit value and will use scanning device 310. Or, the person with claim card 304 borrows a smartphone; in any case, the redemption value of the can will be credited to the account of the claim card. In this embodiment, the QR code on claim card 304 includes not only an anonymous user identifier of that card but also a Web address of a Web page. In one particular embodiment, the anonymous user identifier is a 128-bit unique identifier.

As explained above, in step 408 (arrows 3 and 4) device 310 requests and downloads the Web page from Web application 342 which includes a custom scanner window 312, custom code, etc. The custom code may then send the CUID (arrow 1b) to the Web application for basic verification of its authenticity, and may optionally (arrow 2) send the CUID to the database 350 to verify it is a legitimate identifier.

Assuming that the CUID from the claim card 304 is legitimate, then in step 412 (arrows 5 and 6) the user is allowed to scan the QR code 322 on the container 320 with the custom scanner window of device 310. QR code 322 includes an encoded form of a unique identifier for container 320 which is then input to the custom code of device 310. This collection container's unique identifier may be transmitted to the Web application 342 for verification of authenticity, tracking purposes or to determine if the container is full, and this interaction may occur immediately before the can is scanned or during the interaction of step 418 (arrows 9 and 10). Scanning code 322 suggests that its user is at the collection container 320 (and presumably will toss the can in the container). Precautions can be taken to prevent fraud as described in more detail below.

In step 418 (arrows 7 and 8) the user scans the QR code 332 on can 330 using the camera of device 310 in conjunction with the custom scanner window of the downloaded Web page. As mentioned, code 332 includes a unique identifier (UID) that uniquely identifies that particular can 330 that is captured by the custom code of the Web page 312.

In step 422 (arrows 9 and 10) numerous interactions occur between Web page 312, Web application 342 and the cloud database 344 in order to produce a result which is sent in the form of a code from cloud database 344 through to the Web page 312 in the smartphone. The can UID is sent from the smartphone to the Web application 342 and the Web application queries the records of the cloud database 344 using the UID in order to determine if this is a valid can UID, and if so, has this can already been scanned before. If this is a valid can UID and the can has not been scanned before, then the record corresponding to the unique identifier of the scanned can is marked as “deposit claimed” (or other such indication that this can has now been scanned and may not be scanned again in order to obtain credit). Other additional metadata may also be recorded within the record for this particular can such as the unique identifier of the collection container, date, time stamp and the geolocation of the collection container, and each record may also include the deposit value of the can which may be transmitted back to the smartphone. A result is returned to the Web page 312 on the mobile device 310.

In step 426 the result is displayed on the smartphone to indicate the status of the can that was just scanned using the custom code of the Web page. This result may be indicated visually using text, graphics, color, etc. or may be displayed audibly using tones, music, a recorded message (e.g., “can accepted”), etc. Thus, at the moment of a scan of a can, the audio or visual feedback from the smartphone to the user is given to indicate one of three possible results: 1 [a successful scan and deposit claim]; 2 [valid UID but deposit claimed previously]; or 3 [scan error]. In other words, a result of 1 indicates that the can UID was found in the can database database and has not previously been scanned and claimed, accordingly, control moves to step 438. A result of 2 indicates that the UID found on the can is a valid UID found in the database, but this can has already been scanned and claimed by someone else and no deposit will be credited; accordingly, control moves to step 430. A result of 3 indicates that no UID was found during the scan, any UID found is not valid or some other error; accordingly, control moves to step 434. After the display of alert in steps 430 or 434 control returns to step 418 and the Web page and smartphone are immediately ready to scan another can. Thus, if more cans are present they can be scanned in rapid succession without needing to touch any other UI elements like buttons or icons.

In step 438 (arrow 11) the anonymous user identifier originally identified in step is credited with a value corresponding to can 330 in database 350. This value may be equivalent to the original deposit paid for the can (if any), or may be a greater or lesser amount. As mentioned above, there is no user account in the system nor in database 350; the value is only associated with an anonymous user identifier in database 350 which is based upon, associated with, or the same as, the anonymous user identifier present in the machine-readable code of claim card 304.

During interaction (9, 10) the anonymous user identifier is provided to Web application 342 which may then update database 350 with this user identifier and the value to be credited to that identifier during interaction (11). If the identifier already exists within the database in a record then the current value is added to the existing value at that record, while if no identifier exists then a new record is created with the new value. In step 442 the user tosses can 330 into collection container 320 and continues scanning and depositing other cans or the process ends. The collection container is then emptied or picked up, transported and processed as usual.

### Digital Deposit Return System with No Requirement for a User to Own a Smartphone, Bin with Embedded Scanning Device

The above embodiment describes the use of a loose, ruggedized scanning device that is located nearby the collection container. The below embodiment describes a scanning device known as a ClaimScanner™ that is solidly embedded on top of the collection container (i.e., any suitable recycling bin) that is used to scan a claim card and a can to be recycled. Any person wishing to recycle and redeem a can only needs a claim card and not only does not need to own a smartphone but also does not need to use one in order to redeem a can; the built-in scanning device is used.

FIG. 5 illustrates a digital deposit return system (DDRS) 500 enabled with a built-in scanning device 510, such as any suitable smartphone. In this embodiment a person uses the built-in scanning device 510 in order to scan his or her claim card 504 and cans 530 for recycling which will be deposited into the container.

Scanning device 510 is any suitable smartphone or mobile device firmly embedded or attached in any suitable location upon the collection container, and may even be firmly attached to any suitable nearby surface that is convenient for scanning cans and then tossing them into the container 520. Preferably, scanning device 510 is trickle-charged by small solar cell 524 (or is connected to mains power), and may be made from recycled materials and ergonomically designed to scan cans and bottles. It may also include a shaded display, a camera conveniently oriented for scanning before disposal and is arranged to also scan lid-printed data matrix codes. It may be used in public and semi-public environments. Using commercially available software, this embedded smartphone is preferably locked in a “kiosk” mode which locks the device into one application, or even to a single Web page. Thus, device 510 is already displaying Web page associated with Web application 542 and is executing custom code and ready to scan any claim card or can using a custom scanner window 512. It includes the unique identifier of collection container 520, meaning that container 520 need not display any QR code and it is not necessary to scan any such code on container 520. Alternatively, for embodiments where a different type of machine-readable code is used on a claim card or on a can, or for where a different type of physical tag is used, device 510 may come equipped with standard hardware and software to read those codes or tags.

Shown is a claim card 504 that includes a machine-readable code such as a QR code (or a physical tag) that includes a unique identifier for that card which will be used to accrue and store value for deposits made into the anonymous user identifier database 550. The card unique identifier (CUID) is associated with the physical card but in practice it represents the user who carries the card, who uses the card to make deposits and who then later uses the card to withdraw or spend value from the database, although the CUID or the card do not need to include personal user identification. Card 504 may be of any size, typically it will be the same size as a credit card, although it may be even smaller and of any shape as long as it has a surface large enough for a machine-readable code that can be scanned (or suitable to contain a physical tag).

Collection container 520 is any suitable container, bin, receptacle, bag, etc. suitable for holding food and beverage containers to be recycled. As mentioned earlier, can 530 is any suitable food or beverage container such as a glass or plastic bottle, tin or aluminum can, carton, or any type of food or beverage packaging on which it is practical to place a machine-readable code 532. Code 532 may be a serialized QR code. Other types of machine-readable codes may be used or a physical tag may be fixed to or placed within the container. In one particular embodiment, an NFC code is used.

System platform 540 includes any number of scalable Web server computers executing one or more Web applications 542 in communication an industrial strength, hyper-scalable cloud database 544, capable of storing and handling the tens of billions of records—one for every uniquely identified food or beverage container that is produced—that executes upon suitable mainframe computers located within a corporation or within a third-party cloud service and available over the Internet or other private network.

Anonymous user identifier database 550 is any suitable scalable database executing upon a server computer (which may be located co-extensively with system platform 540 remote location) capable of handling the many thousands or millions of records that will associate an anonymous identifier for each user of the system with the credit that each has accrued when returning food or beverage containers. It is notable that database 550 does not need to include personally-identifiable information about each user such as an e-mail address, name, password, user name, or other type of account information.

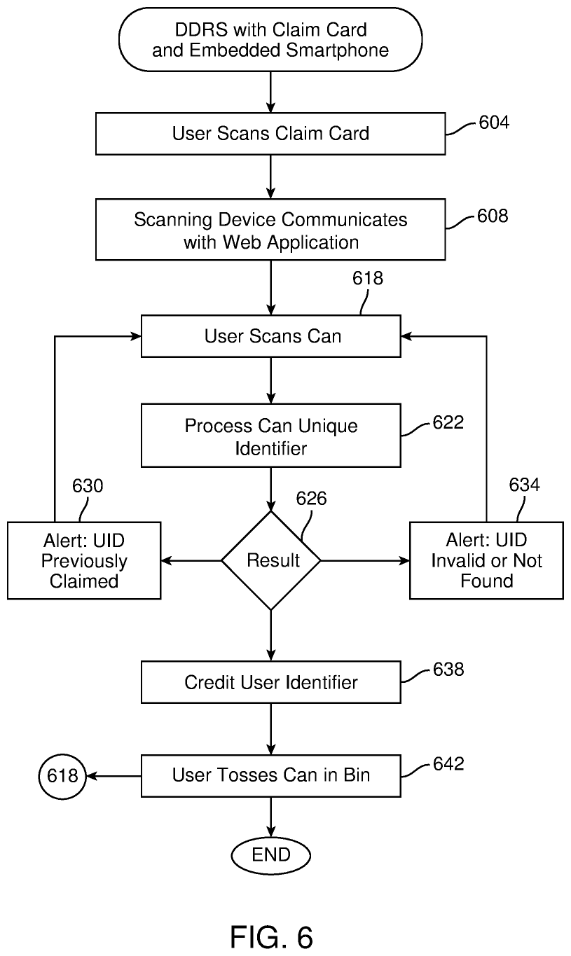

FIG. 6 is a flow diagram describing how the system of FIG. 5 operates. At this point in time, can 530 has entered the stream of commerce as described above. In step 604 (arrow 1) any person scans the QR code on claim card 504 using scanning device 510. In this embodiment, the QR code on claim card 304 includes an encoded anonymous user identifier of that card (CUID). In one particular embodiment, the anonymous user identifier is a 128-bit unique identifier.

In step 608 (arrow 2a) device 510 communicates with Web application 542 using the Web page of that application which has already been preloaded onto device 510. In an alternative embodiment, device 510 requests and downloads the Web page from Web application 542 (using an address preloaded into device 510) which includes a custom scanner window 512, custom code, etc. The custom code may then send the CUID to the Web application for basic verification of its authenticity, and may optionally (arrow 2b) send the CUID to the database 550 to verify it is a legitimate identifier. Preferably, if the claim card does not include an appropriate CUID then device 510 will provide an error message and will not be able to scan can 530.

Assuming that the CUID from the claim card 504 is legitimate, then in step 618 (arrow 3) the user scans the QR code 532 on can 530 using the camera of device 510 in conjunction with the custom scanner window 512 of the downloaded Web page. As mentioned, code 532 includes a unique identifier (UID) that uniquely identifies that particular can 530 that is captured by the custom code of the Web page 512. As previously mentioned, device 510 already includes the unique identifier of the collection container that may be transmitted to the Web application 542 for tracking purposes or to determine if the container is full.

In step 622 (arrows 4 and 5) numerous interactions occur between device 510, Web application 542 and the cloud database 544 in order to produce a result which is sent in the form of a code from cloud database 544 through to the Web page in device 510. The can UID is sent from the embedded device to the Web application 542 and the Web application queries the records of the cloud database 544 using the UID in order to determine if this is a valid can UID, and if so, has this can already been scanned before. If this is a valid can UID and the can has not been scanned before, then the record corresponding to the unique identifier of the scanned can is marked as “deposit claimed” (or other such indication that this can has now been scanned and may not be scanned again in order to obtain credit). Other additional metadata may also be recorded within the record for this particular can such as the unique identifier of the collection container, date, time stamp and the geolocation of the collection container, and each record may also include the deposit value of the can which may be transmitted back to the smartphone. A result is returned to the embedded device 510.

In step 626 the result is displayed on device 510 to indicate the status of the can that was just scanned using the custom code. This result may be indicated visually using text, graphics, color, etc. or may be displayed audibly using tones, music, a recorded message (e.g., “can accepted”), etc. Thus, at the moment of a scan of a can, the audio or visual feedback from device 510 to the user is given to indicate one of three possible results: 1 [a successful scan and deposit claim]; 2 [valid UID but deposit claimed previously]; or 3 [scan error]. In other words, a result of 1 indicates that the can UID was found in the can database database and has not previously been scanned and claimed, accordingly, control moves to step 638. A result of 2 indicates that the UID found on the can is a valid UID found in the database, but this can has already been scanned and claimed by someone else and no deposit will be credited; accordingly, control moves to step 630. A result of 3 indicates that no UID was found during the scan, any UID found is not valid or some other error; accordingly, control moves to step 634. After the display of alert in steps 630 or 634 control returns to step 618 and device 510 is immediately ready to scan another can. Thus, if more cans are present they can be scanned in rapid succession without needing to touch any other UI elements like buttons or icons.

In step 638 (arrow 6) the anonymous user identifier originally identified in step 604 is credited with a value corresponding to can 530 in database 550. This value may be equivalent to the original deposit paid for the can (if any), or may be a greater or lesser amount. As mentioned above, there is no need for a user account in the system nor in database 550; the value is only associated with an anonymous user identifier in database 550 which is based upon, associated with, or the same as, the anonymous user identifier present in the machine-readable code of claim card 504.

During interaction (6) the anonymous user identifier is provided to database 550 and the value to be credited to that identifier. If the identifier already exists within the database in a record then the current value is added to the existing value at that record, while if no identifier exists then a new record is created with the new value. In step 642 the user tosses can 530 into collection container 520 and continues scanning and depositing other cans or the process ends. The collection container is then emptied or picked up, transported and processed as usual.

### Redemption of Value Accrued to a User Identifier

As mentioned above, based upon the number of cans scanned with an individual's smartphone having a stored anonymous user identifier, scanned using an arbitrary smartphone (or dedicated scanning smartphone) along with a claim card, or scanned using a claim card and a claim bin having a dedicated, embedded smartphone scanner, value will be accrued in database 150 according to the anonymous user identifier used at the time of scanning. This value may be redeemed by a user in a variety of matters.

The reclaimed deposit may be added to a digital wallet (of the user's smartphone), sent out as a digital voucher to the e-mail address of a user (on many smartphones this can be done anonymously using the mailto: Web function) or otherwise made available to the user. For example, the system may send by electronic mail a cryptographically-protected digital voucher to the e-mail address of the user, or to a specialized email address of a bank account, where received vouchers are automatically verified and added to the balance of the bank account.

### Fraud Detection and Prevention

In the embodiments of FIG. 1 and FIG. 3 above, scanning of the QR code on the collection container suggests that the individual performing the scanning is actually at the collection container and will more than likely toss the can into the collection container after scanning. Unfortunately, though, and as mentioned above, an unscrupulous individual may take a photograph of the QR code on the collection container and transmit it or reproduce it such that he or she (or another individual) can scan cans or claim cards a location remote from the actual collection container with no intention of tossing the cans into the collection container. Accordingly, additional measures may be used in order to deter this type of fraud.

In a first measure, geographic locking or “geo-locking” is used to lock the collection container to a specific geographic location and to ensure that the user depositing a can is also at that location. In one particular embodiment, at first scan of the collection container QR code (or by means of an authorized administrator scan or simple manual entry) the geographic location of the collection container is requested from the scanning smartphone (i.e. the precise GPS coordinates) and registered in the cloud database 144. In other words, there is a database of all collection containers including their unique identifiers and parameters for each container such as their physical location, i.e. the GPS coordinates. Then, similarly, at any subsequent scan of that QR code on the collection container by a user attempting to redeem a can, those registered coordinates are compared with a set of coordinates requested in real time from the scanning smartphone indicating the precise location of the user. Too much discrepancy between the sets will invalidate the reclaim request and communicate this to the user; thus, the user will be informed that no value will be credited for the can. Even before a can is scanned, a message may be displayed on the user's smartphone indicating the reason for the denial immediately after the bogus collection container QR code is scanned.

In a second measure, time locking is used to ensure that the user is physically present at the location of the collection container. Time locking may be used for locations or use cases where geographic locking is not optimal, e.g. there is no good GPS reception, such as inside a building, or the user has disabled the GPS on his or her smartphone. Time locking uses an “active QR code”: it substitutes the QR code sticker on the collection container with a small device—resembling a dynamic supermarket price tag—that contains a CPU chip and circuit board with a display showing a continuously changing QR code that has a pattern that changes over time in a cryptographically deterministic way, along with the required unique identifier of the collection container. Thus, the Web application compares the dynamic pattern captured from a scan of the active QR code on the collection container with the correct pattern that it is also able to generate using the same cryptographically deterministic way; any large discrepancy results in the transaction being denied and no value being credited for the can. As the dynamic QR code pattern on the collection container changes over time, and since the Web application is also aware of how this dynamic pattern changes over time, the Web application is able to compare the pattern submitted by the user with its own internally generated pattern in order to determine if the user is actually present at the collection container. Any bogus photographs of the active QR code will only contain an older pattern that will not match with the current pattern when the transaction occurs. In a similar fashion as geo-locking, time locking prevents the successful scanning of a collection container QR code outside of the immediate vicinity of a valid, registered collection container.

In variations of the second measure, any aspect of the QR code may change over time and the Web application will be aware of which aspect is changing. For example, the dynamic QR code may include any code, text, number, symbols etc. that change over time and which are also known to the Web application. Thus, the dynamic QR code incorporates a time-changing element that the Web application can also reproduce in order to compare the time-changing element from the user scan with its own internally generated time-changing element. The code, text, number, symbols etc. may change simply over time or may change in a seemingly random way, as long as the Web application is able to reproduce that change (in a deterministic way) in order to derive the same code that the dynamic QR code produces. Use of this time-changing element also extends to a physical tag (instead of a machine-readable code) which may also incorporate a time-changing element (e.g., a changing code) of which the Web application is also aware.

As mentioned above, time locking may also be implemented using a dynamic NFC tag. When it is programmed by the system implementer, its time-varying response will be known. When the user scans a dynamic NFC tag on the collection container its time-varying response is submitted to the Web application which will compare the response from the collection container with the expected time-varying response that the Web application is aware of. A match indicates that the user is actually present at the collection container.

In a third measure, an analysis of the video stream during a scan of the QR code on the collection container is performed. In the embodiment of FIG. 1 mobile device 110 scans QR code 122 on container 120 and in the embodiment of FIG. 3 scanning device 310 scans QR code 322 on container 320. All videos of this scanning process are recorded and used to train a neural network to judge the validity of a scan. Using an approach called feature extraction, this neural network “learns” about the actual QR code on the container itself, any background images, the correct color of the container, exposure (including the lighting variations compared to recent scans which should be realistic and proportional to time interval), scenery movement during scan, and any other image features characterizing a true scan of the QR code on the container in its fixed location. These features are quantified and stored in an array in the cloud database to serve as a real-time big data reference for any scan happening. When extracted features of that scan are separately or collectively too different from the other stored values, the scan is rejected. This process is called anomaly rejection and resembles the rejection of credit card transactions that show unusual characteristics.

Therefore, when a user is scanning the QR code on the collection container during an actual transaction, the software of the mobile device or scanning device records a short video during this scan which is immediately analysed within the scanning device and/or the Web application to extract above mentioned features and to compare them with the array of existing scans in order to validate or reject a scan and its associated deposit claim.

Other attempts at fraud may also occur which involve taking a photograph or video of the QR codes on cans in a supermarket and using those photographs or video to simulate the scanning of an actual at an actual collection container. For example, an unscrupulous individual may enter a supermarket and take numerous photographs of the QR codes of cans or bottles on the shelves (a “physical” fraudulent approach) and then go outside to the nearest collection container either with those printed photographs or with the photographs on a screen of a mobile device. At the collection container, the individual scans the fake QR codes in the photographs (instead of an actual QR code on the can) in the context of any of the embodiments of FIG. 1, 2 or 3. In order to combat this fraud, similar to the third measure above, during a scan of the can (using device 110, device 310 or device 510) a video stream is recorded and compared to known good and bogus video streams of a can being scanned in order that Web application 142 can send an alert to the device and decline a claim for a can if appropriate. As above, benchmark videos of actual cans being scanned may be recorded ahead of time and then compared to a user video of a scan of a can that has been stored in an array in the cloud database. Such a comparison may occur after the fact or in real time.

In a preferred embodiment, a neural network is trained with known valid scans of actual cans being scanned at the collection container. The neural network will extract features from these videos in order to validate or reject using feature extraction as described above. Preferably, the user scan of a can is fed in real time to the neural network controlled by the Web application 142, relevant features are extracted, and the neural network makes a decision in real time as to whether user scan is valid or is bogus. Another technique for training the neural network on valid scans is to assume that the large majority of user scans will be valid scans and using those as training material for valid scans (and throwing out any exceptions). Features that may be extracted from the videos in order to compare valid against potential bogus videos include: color composition of the photograph, the color temperature, the light intensity, any movement in the video, background objects, etc. Further, a classifier model may be used to classify whether the scan is of a 3-D object (a valid scan) or of a photograph of a QR code (an invalid scan). Other techniques using artificial intelligence may also be used to differentiate between a scan of an actual can have a collection container versus scan of a photograph of a QR code on the can.

Alternatively, in a “digital” fraudulent approach to scanning cans, an individual takes videos of the QR codes on cans in the supermarket as if the video were showing the scan of that can at a collection container. Other than being taken at a different location, such a video may be hard to differentiate from an actual video of a scan of a can at a collection container since it is a video of the QR code on an actual can. The individual may then forward those videos (through a suitable hack) to the backend Web application (using a suitable API) and attempt to impersonate a user actually scanning real cans at a collection container. Above mentioned video-based anomaly rejection techniques work against this type of exploit.

Time locking of the scanning of a can may also be used to deter this digital fraudulent approach. Because the mobile device or scanning device is in communication with the Web application at the time of scanning the can, the Web application may send a time-dependent parameter to the device that requires scanning of the can to happen in a particular manner at that time in order for the scan to be determined legitimate; this parameter may change every ten seconds, every minute, every hour, etc. This time-dependent parameter may be virtually any parameter that changes how the scan of the can is performed at a particular time and thus enables the Web application to determine if the video of the scan from the mobile device or scanning device happened at the time. For example, the time-dependent parameter may dictate how many times the flashlight of the telephone should flash during scan of the can, e.g. twice, three times, etc. If the Web application does not detect these number flashes in the video of the scan of the can this means that the scan was fraudulent and may have occurred upon a scan of a can in a supermarket.

Or, the time-dependent parameter dictates where the scanning reticle appears on the device screen in order to scan the QR code can. For example, if the screen is divided into nine squares (rectangles), the scanning reticule may rotate to each of these nine locations depending upon the time, and may rotate every ten seconds, every minute, every hour, etc. Typically, a scanning reticule may appear in the center of a screen and the user centers a QR code in that screen in order to scan it. Using this time-dependent parameter, the scanning reticule may appear in the top left corner, in the top third in the middle, in the top third of the far right, etc., thus requiring that the user move his or her mobile device or scanning device (or move the can) in order that the QR code on the can appears in a particular location on the screen. The Web application is aware of in which reticule the QR code must appear depending upon the time, and if a scanning video has the QR code in a different location it may deem to be a fraudulent video. This time-dependent technique would make it difficult for a fraudulent user to replay photos or videos made earlier in a supermarket.

In a sixth embodiment, a fairly straightforward time-dependent measure that can be taken is to require that the code of the can and the time-dependent dynamic QR code be scanned at the same time in order to extract and scan both codes from the same picture. In that case it may be desirable to layout the top of the collection container in such a way that it is easy to put and frame the can next to the dynamic QR code. Optionally, this technique can be combined with anomaly rejection for maximum results.

Unscrupulous individuals may also attempt to guess the unique identifiers of each can as part of a fraud attempt and attack upon the cloud database 144 or when scanning bogus QR codes of cans that include unique identifiers that have been guessed. In order to prevent such fraud, it is preferable to use unique identifiers on cans and other food and beverage containers and for redemption that are long enough and random enough that they cannot be guessed. If these codes were too short and were sequential, then an individual may be able to guess existing codes in cloud database 144. In a preferred embodiment, a unique identifier for each can is a 16-character (96-bit base64-URL-encoded) random string which is then encoded in a data matrix code. This choice is a balance between randomness/entropy and what is able to be printed at the extreme production speed of certain products such as cans. It is preferable to use high quality random numbers, generated either by True Random Number Generators (TRNGs) or by Pseudorandom Number Generators (PRNGs), processes which are well known and documented. Larger countries which have a greater number of cans to be recycled (Germany's yearly 40B against Belgium's 5B for example) may need slightly longer codes in order to offer the same order of “unguessability.” Similarly, a pilot project in Belgium with only 100K items in scope was conducted with only 10- or 12-character base64-URL encoded data matrix codes.

### Full Collection Containers

Another matter to consider is what to do when the container is full—an individual still may scan the can but then will be obligated to throw the can in the grass. Therefore, we provide a capacity parameter for each collection container that is part of the container's database record in cloud database 144 to indicate the maximum capacity in number of cans before the container is considered “full.” In other words, in addition to keeping track of every can and its parameters in cloud database 144, this database (or a separate database) keeps track of every collection container by its own unique identifier and records various parameters associated with the container such as how many cans have been tossed in, the volume of each can, size of the collection container, type of each can tossed in, etc. Since cans and other containers may have different sizes, a volume difference according to the type of can or bottle can be taken into account in making the calculation as to whether a particular collection container is full or not.

When the calculation of a number of cans deposited into a collection container, a volume per can, and the size of the collection container indicates that the container is full, it will not be possible to successfully scan and reclaim cans at that container, and a “full” indicator will light up at a central console in a collection operations center to trigger the collection process; or a more automated equivalent of that whole flow may occur. Once Web application 142 determines that the collection container is full, an alert is also displayed upon mobile device 110, scanning device 310 or scanning device 510 indicating that the container is full and no credit will be received for any can scanned. The same process also applies to the containers of type “home can collection bags” (e.g. those known in Belgium today as “PMD bags”). These bags accrue the deposits claimed and collected cans until their built-in digital limit is reached. At that point they will notify the user and stop accepting scans and cans.

### Auxiliary Functions

Auxiliary functions are provided for collection container, can or collection bags. Regarding the collection container, if one scans its QR code after some form of authentication or authorization you will see a list of available functions such as: read the status of the container (never used/started/full/empty); install and register this container at the current location, which will take the geographic location of the scanning phone and enter it into the container's record in the database as it's registered location to compare any subsequent scans against; read remaining capacity, e.g., 28 of 75 maximum deposits remaining; and mark this container as processed and thus reset to empty.

It is interesting to note that the simple addition of a passive sticker (or a non-connected dynamic QR code device) creates a kind of poor man's IoT device, with parameters that are continuously updated in an associated cloud parameter set and that can drive other processes like a re-arranged trash collection tour after a small weekend festival in the local park.

Regarding auxiliary functions on the can, these may be triggered by smartphone scanning or by detecting some form of serialized tag or code. This may be either a serialized QR code or the combination of a generic, batch-specific QR code with a machine-readable serial number or code on the bottom of the can, as outlined above. These functions include: check whether the deposit on this can is already claimed or not, possibly with other specific lifecycle details; start a tutorial on how the system works; show statistics on the overall performance of the collection system; provide an entry point for the beverage brand to use for dynamic marketing campaigns related to brand awareness and equity, customer intimacy, track and trace, circularity etc.

There may also be auxiliary functions provided on the outside of a roll of collection bags (e.g. before buying in the supermarket) triggered by smartphone scanning or detecting some form of serialized tag or code. These functions include: assert that all the codes on all the bags inside the roll are still valid and unused; and show an explanation or tutorial on the system (for candidate buyers).

Auxiliary centralized functions are based on metadata in records, accessible on a web console and include functions such as: list installed collecting containers with all their attributes such as location, status (never used/started/full/empty), date and time of installation, date and time of last scan, maximum capacity in number of beverage packages; and list collecting containers that are full or nearly full and need to be emptied soon.

### Other Embodiments

The invention includes these other embodiments.

C1. In a Web application on a server computer, a method of crediting a user:
receiving over a network connection a request from a mobile device for a Web page, said request identifying a physical collection container;
sending said Web page to said mobile device for display in response to said receiving;
receiving via said Web page on said mobile device a unique identifier (UID) of a physical container or physical packaging;
querying a database with said received physical UID and obtaining a result;
receiving over said network connection a unique identifier (UID) from said mobile device identifying a claim card; and
based upon said result, crediting or not crediting a user account associated with said claim card UID with monetary value associated with said physical UID of said physical container or physical packaging.
   C2. A method as recited in claim C1 wherein said request is based upon scanning a code of, or detecting a tag of, said collection container using said mobile device.
   C3. A method as recited in claim C1 wherein said received physical UID is based upon scanning a code of, or detecting a tag of, said physical container or said physical packaging.
   C4. A method as recited in claim C1 wherein said received claim card UID is based upon scanning a code of, or detecting a tag of, said claim card.
   C40. A method as recited in claim C1 wherein when said result indicates that said physical container or said physical packaging has not previously been deposited, said method further comprising:
crediting said user account associated with said claim card UID with monetary value associated with said physical UID of said physical container or physical packaging.
   C41. A method as recited in claim C1 wherein when said result indicates that said physical container or said physical packaging has not previously been deposited, said method further comprising:
said Web page on said mobile device crediting a digital wallet of said user account associated with said claim card UID with monetary value.
   C42. A method as recited in claim C1 wherein when said result indicates that said physical container or said physical packaging has previously been deposited, said method further comprising:
not crediting said user account associated with said claim card UID with any monetary value.
   C5. A method as recited in claim C1 wherein when said result indicates that said physical container or said physical packaging has not previously been deposited, said method further comprising:
said Web page on said mobile device sending a digital voucher to an e-mail address associated with said claim card UID with monetary value.
   C7. A method as recited in claim C1 further comprising:
receiving at said Web application from said mobile device geographic coordinates of the location of said mobile device;
comparing said mobile device geographic coordinates with previously-stored geographic coordinates of said physical collection container identified in said request from said mobile device; and
denying a claim for credit when said mobile device geographic coordinates do not sufficiently match said previously-stored geographic coordinates, and approving a claim for credit when said mobile device geographic coordinates do match said previously-stored geographic coordinates.
   C8. A method as recited in claim C1 further comprising:
determining, by said Web application, that said physical collection container identified in said request from said mobile device is full; and
denying a claim for credit when said physical collection container is full.
   C9. A method as recited in claim C1 wherein said mobile device is a telephone, tablet computer, smart watch, or handheld scanner.
   C11. A method as recited in claim C1 wherein said request is based upon scanning a code of, or detecting a tag of, said collection container using said mobile device and includes a current time extracted from said code or tag, said method further comprising:
comparing said extracted current time with a current time of said server computer; and
denying a claim for credit when said extracted current time does not match said current time of said server computer, and approving a claim for credit when said extracted current time does match said current time of said server computer.
   C12. A method as recited in claim C11 wherein said code or said tag changes continuously in order to embed said current time within said code or said tag.
   C13. A method as recited in claim C12 wherein said physical collection container includes an electronic circuit in order to continuously change said code or said tag.
   E1. In a Web application on a server computer, a method of detecting fraud:
sending, from a Web application over a network connection to a computing device, a value of a time-dependent parameter that modifies an image or video produced by a camera of said computing device while performing a scan, said time-dependent parameter changing within said Web application;
receiving over said network connection from said computing device an image or a video of a scan of a machine-readable code of a physical container or physical packaging, said machine-readable code including a unique identifier of said physical container or physical packaging (CUID);
determining whether said received image or video is modified due to said value of said time-dependent parameter and when it is determined that said image or video is so modified, transmitting a message to said computing device indicating that a transaction based upon said CUID may proceed, and when it is determined that image or video is not so modified, terminating said transaction based upon said CUID.
   E2. A method as recited in claim E1 wherein said time-dependent parameter dictates an exposure value, number of flashes, or where a reticle of said scan appears on the screen of said computing device.
   E3. A method as recited in claim E1 further comprising:
performing said determining in real time and transmitting said message to said computing device during said transaction based upon said CUID.
   E4. A method as recited in claim E1 wherein said computing device is a mobile device, said method further comprising:
receiving at said Web application a unique identifier of a physical collection container (CCUID) based upon a scan of a machine-readable code on said physical collection container;
in response to said receiving of said CCUID, downloading a Web page to said mobile device, wherein said scan is performed using said Web page to produce said image or video; and
determining that said image or video is so modified and approving a claim for credit of said physical container or physical packaging.
   E5. A method as recited in claim E1 wherein said computing device is a scanning device, said method further comprising:
receiving at said Web application a unique identifier of a physical card (card UID) based upon a scan of a machine-readable code on said physical card;
in response to said receiving of said card UID, downloading a Web page to said scanning device, wherein said scan is performed using said Web page to produce said image or video; and
determining that said image or video is so modified and approving a claim for credit of said physical container or physical packaging.
   E6. A method as recited in claim E1 wherein said computing device is a scanning device embedded within said physical container, said method further comprising:
receiving at said Web application a unique identifier of a physical card (card UID) based upon a scan of a machine-readable code on said physical card by said embedded scanning device;
in response to said receiving of said card UID, sending said value of said time-dependent parameter to said scanning device, wherein said scan is performed using said value to produce said modified image or video; and
determining that said image or video is so modified and approving a claim for credit of said physical container or physical packaging.
   G1. In a Web application on a server computer, a method of detecting fraud:
receiving over a network connection from a mobile device a unique identifier of a physical collection container (CCUID), wherein said CCUID being based upon scanning of a machine-readable code of, or detecting a tag of, said physical collection container using said mobile device;
receiving over said network connection from said mobile device an image or a video from said scanning of said machine-readable code or from said detecting of said tag of said physical collection container;
analyzing said image or video using anomaly rejection and determining that said image or video is legitimate or determining that said image or video is fraudulent based upon results of said anomaly rejection; and
allowing said transaction based upon said CCUID to proceed when it is determined that said image or video is legitimate, and terminating said transaction based upon said CCUID when it is determined that said image or video is fraudulent.
   G9. A method as recited in claim G1 further comprising:
extracting features from said image or video and comparing said extracted features to stored features of previous images or videos of previous scanning of machine-readable codes or detecting of tags of physical collection container.

### Computer System Embodiment

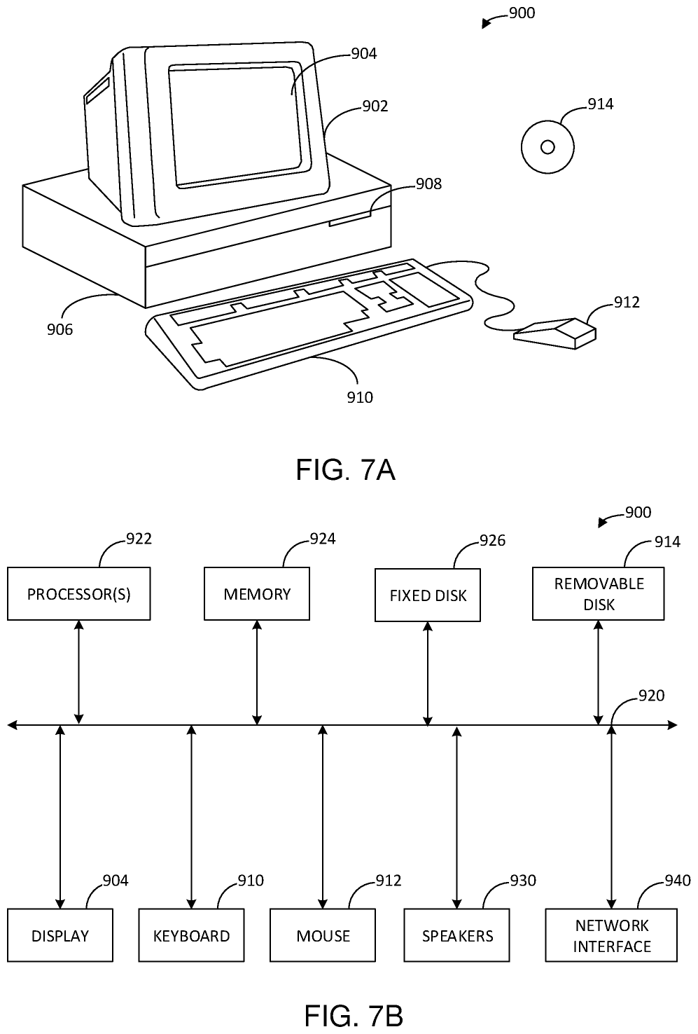

FIGS. 7A and 7B illustrate a computer system 900 suitable for implementing embodiments of the present invention. FIG. 7A shows one possible physical form of the computer system. Of course, the computer system may have many physical forms including an integrated circuit, a printed circuit board, a small handheld device (such as a mobile telephone or PDA), a personal computer or a super computer. Computer system 900 includes a monitor 902, a display 904, a housing 906, a disk drive 908, a keyboard 910 and a mouse 912. Disk 914 is a computer-readable medium used to transfer data to and from computer system 900.

FIG. 7B is an example of a block diagram for computer system 900. Attached to system bus 920 are a wide variety of subsystems. Processor(s) 922 (also referred to as central processing units, or CPUs) are coupled to storage devices including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bi-directionally to CPU 922; it provides additional data storage capacity and may also include any of the computer-readable media described below. Fixed disk 926 may be used to store programs, data and the like and is typically a secondary mass storage medium (such as a hard disk, a solid-state drive, a hybrid drive, flash memory, etc.) that can be slower than primary storage but persists data. It will be appreciated that the information retained within fixed disk 926, may, in appropriate cases, be incorporated in standard fashion as virtual memory in memory 924. Removable disk 914 may take the form of any of the computer-readable media described below.

CPU 922 is also coupled to a variety of input/output devices such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

We claim:

1. In a Web application on a server computer, a method of crediting a user:
receiving over a network connection a request from a mobile device for a Web page, wherein said request being based upon scanning a code of, or detecting a tag of, a physical collection container using said mobile device;
sending said Web page to said mobile device for display in response to said receiving;
receiving via said Web page on said mobile device a unique identifier (UID) of a physical container or physical packaging;
querying a database with said received UID and obtaining a result; and
sending said result to said Web page on said mobile device, said result indicating whether or not said UID of said physical container or said physical packaging has previously been received for credit.

2. A method as recited in claim 1 wherein said received UID is based upon scanning a code of, or detecting a tag of, said physical container or said physical packaging.

3. A method as recited in claim 1 wherein when said result indicates that said UID of said physical container or said physical packaging has not previously been received, said method further comprises:
receiving from said mobile device a mobile unique identifier (MUID) stored within said mobile device; and
crediting an entry in a user database identified by said MUID with a monetary value.

4. A method as recited in claim 1 wherein when said result indicates that said UID of said physical container or said physical packaging has not previously been received, said method further comprises:
said Web page on said mobile device crediting a digital wallet on said mobile device with monetary value.

5. A method as recited in claim 1 wherein when said result indicates that said UID of said physical container or said physical packaging has not previously been received, said method further comprises:
said Web page on said mobile device sending a digital voucher to an e-mail address of said user with monetary value.

6. A method as recited in claim 3 wherein said result from said database includes a monetary value corresponding to said physical container or said physical packaging identified by said UID, said method further comprising:
crediting said entry in said user database with said included monetary value.

7. A method as recited in claim 1 further comprising:
receiving at said Web application from said mobile device geographic coordinates of the location of said mobile device;
comparing said mobile device geographic coordinates with previously-stored geographic coordinates of said physical collection container identified in said request from said mobile device; and
denying a claim for credit when said mobile device geographic coordinates do not match said previously-stored geographic coordinates, and approving a claim for credit when said mobile device geographic coordinates do match said previously-stored geographic coordinates.

8. A method as recited in claim 1 further comprising:
determining, by said Web application, that said physical collection container is full based upon information identified in said request from said mobile device, wherein said result sent to said Web page of said mobile device also indicates that a claim for credit is denied.

9. A method as recited in claim 1 wherein said mobile device is a telephone, tablet computer, smart watch, or handheld scanner.

10. A method as recited in claim 1 wherein when said result indicates that said UID of said physical container or said physical packaging has not previously been received, said method further comprises:
sending an indication of monetary value along with said result to said mobile device; and
said Web page on said mobile device crediting a digital wallet on said mobile device with said monetary value.

11. A method as recited in claim 1 wherein said request is based upon scanning a code of, or detecting a tag of, said collection container using said mobile device and includes a current time-varying code extracted from said code or tag, said method further comprising:
comparing said extracted current code with a current code of said server computer; and
denying a claim for credit when said extracted current code does not match said current code of said server computer, and approving a claim for credit when said extracted current code does match said current code of said server computer.

12. A method as recited in claim 11 wherein said code or said tag changes over time in order to embed said current code within said code or said tag.

13. A method as recited in claim 12 wherein said physical collection container includes an electronic circuit in order to continuously change said code or said tag.

14. In a Web application on a server computer, a method of crediting a user:
receiving over a network connection a unique identifier (UID) from a computing device identifying a claim card;
receiving over said network connection from said computing device a unique identifier (physical UID) of a physical container or physical packaging;
querying a database with said received physical UID and obtaining a result from said database; and
sending said result to said computing device.

15. A method as recited in claim 14 wherein said received claim card UID is based upon scanning a code of, or detecting a tag of, a claim card using said computing device.

16. A method as recited in claim 14 wherein said received physical UID is based upon scanning a code of, or detecting a tag of, said physical container or said physical packaging using said computing device.

17. A method as recited in claim 14 wherein when said result indicates that said physical container or said physical packaging has not previously been deposited, said method further comprising:
crediting a digital wallet associated with said claim card UID with monetary value.

18. A method as recited in claim 14 wherein when said result indicates that said physical container or said physical packaging has not previously been deposited, said method further comprising:
sending a digital voucher with monetary value to an e-mail address of a user associated with said claim card UID.

19. A method as recited in claim 14 wherein said result from said database includes a monetary value corresponding to said physical container or said physical packaging identified by said physical UID, said method further comprising:
sending said monetary value along with said result to a digital wallet associated with said claim card UID.

20. A method as recited in claim 14 further comprising:
determining, by said computing device, that a physical collection container associated with said computing device is full; and
denying a claim for credit when said physical collection container is full.

21. A method as recited in claim 14 wherein said computing device is a telephone, a tablet computer, a smart watch, a handheld scanner or a computer.

22. A method as recited in claim 14 wherein when said result indicates that said physical container or said physical packaging has not previously been deposited, said method further comprising:
sending an indication of monetary value along with said result to a mobile device associated with said claim card UID; and
said mobile device crediting a digital wallet on said mobile device with said monetary value.

23. A method as recited in claim 14 wherein when said result indicates that said physical container or said physical packaging has not previously been deposited, said method further comprising:
crediting a user financial account associated with said claim card UID with monetary value.

24. A method as recited in claim 14 further comprising:
receiving from said computing device a unique identifier of a physical collection container in which said computing device is attached.

25. A method as recited in claim 14 wherein said result is monetary value, said method further comprising:
crediting a user financial account associated with said claim card UID with said monetary value.

26. A method as recited in claim 14 wherein said monetary value is based upon a value of said physical container or said physical packaging.

27. A method as recited in claim 14 wherein when said result indicates that said physical container or said physical packaging has not previously been deposited, said method further comprising:
crediting a user financial account associated with said claim card UID with monetary value after receipt of said indication.

28. A method as recited in claim 14 further comprising:
displaying said result on a screen of said computing device, wherein said result is an indication that said physical container or said physical packaging has not previously been deposited.

29. A method as recited in claim 14 further comprising:
displaying said result on a screen of said computing device, wherein said result being an indication of monetary value of said physical container or said physical packaging.

30. A method as recited in claim 14 further comprising:
displaying said result on a screen of said computing device, wherein said result being a total accrued monetary value of a user financial account associated with said claim card UID.

31. In a Web application on a server computer, a method of detecting fraud:
receiving over a network connection from a mobile device a unique identifier of a physical collection container (CCUID), wherein said CCUID being based upon scanning a machine-readable code of, or detecting a tag of, said physical collection container using said mobile device;
receiving over said network connection a first value for a first element of said machine-readable code or said tag that changes over time within said machine-readable code or within said tag;
comparing said first value with a second value of a second element said Web application that also changes over time in the same manner as said first element; and
determining whether said first value matches said second value and when it is determined that said values do match, transmitting a message to said mobile device indicating that a transaction based upon said CCUID may proceed, and when it is determined that values do not match, terminating said transaction based upon said CCUID.

32. A method as recited in claim 31, said method further comprising:
when it is determined that said values do match, sending a Web page to said mobile device for display;
receiving via said Web page on said mobile device a unique identifier (UID) of a physical container or physical packaging;
querying a database with said received UID and obtaining a result; and
sending said result to said Web page on said mobile device, said result indicating whether or not said UID of said physical container or said physical packaging has previously been received for credit.

33. A method as recited in claim 31 said method further comprising:
when it is determined that said values do match, receiving from said mobile device a unique identifier (UID) of a physical container or physical packaging;
querying a database with said received UID and obtaining a result; and
sending said result to said mobile device, said result indicating whether or not said UID of said physical container or said physical packaging has previously been received for credit.

34. A method as recited in claim 31 wherein said scanning is performed using a native scanning function of said mobile device.

35. A method as recited in claim 31 further comprising:
receiving at said Web application from said mobile device a unique identifier of a card (CUID), wherein said CUID being based upon scanning a machine-readable code of, or detecting a tag of, said card using said mobile device; and
downloading a Web page to said mobile device, wherein said scanning is performed using a scanning function of said Web page.

36. A method as recited in claim 32 further comprising:
denying a claim for credit for said physical container or said physical packaging when said values do not match, and approving a claim for credit when said values do match.

37. A method as recited in claim 33 further comprising:
denying a claim for credit for said physical container or said physical packaging when said values do not match, and approving a claim for credit when said values do match.

38. A method as recited in claim 31 wherein said physical collection container includes an electronic circuit in order to continuously change said first element over time.

39. In a Web application on a server computer, a method of detecting fraud:
receiving over a network connection from a mobile device a unique identifier of a physical collection container (CCUID), wherein said CCUID being based upon a first scan of a machine-readable code of, or detecting a tag of, said physical collection container using said mobile device;
receiving over said network connection from said mobile device a unique identifier of a physical container or physical packaging (CUID), wherein said CUID being based upon a second scan of a machine-readable code of, or detecting a tag of, said physical container or physical packaging using said mobile device, and wherein said first scan and said second scan are the same scan;
receiving over said network connection a first value for a first element of said machine-readable code or said tag of said physical collection container that changes over time within said machine-readable code or within said tag;
comparing said first value with a second value of a second element said Web application that also changes over time in the same manner as said first element; and
determining whether said first value matches said second value and when it is determined that said values do match, transmitting a message to said mobile device indicating that a transaction based upon said CCUID may proceed, and when it is determined that values do not match, terminating said transaction based upon said CCUID.

40. A method as recited in claim 39, said method further comprising:
when it is determined that said values do match, sending a Web page to said mobile device for display;
querying a database with said received CUID and obtaining a result; and
sending said result to said Web page on said mobile device, said result indicating whether or not said CUID of said physical container or said physical packaging has previously been received for credit.

41. A method as recited in claim 39 wherein said scanning is performed using a native scanning function of said mobile device.

42. A method as recited in claim 39 further comprising:
receiving at said Web application from said mobile device a unique identifier of a card (CUID), wherein said CUID being based upon scanning a machine-readable code of, or detecting a tag of, said card using said mobile device; and
downloading a Web page to said mobile device, wherein said scanning is performed using a scanning function of said Web page.

43. A method as recited in claim 39 further comprising:
receiving over said network connection from said mobile device an image or a video of said same scan that includes said machine-readable code of said physical collection container and said machine-readable code of said physical container or physical packaging,
analyzing said image or video using anomaly rejection and determining that said transaction may proceed or determining that said transaction may not proceed based upon results of said anomaly rejection.
